(19) United States
(12) Patent Application Publication
(10) Pub. No.: US 2024/0102127 A1
(43) Pub. Date: Mar. 28, 2024

(54) PROCESS FOR CATHODE ACTIVE MATERIAL PRECURSOR PREPARATION

(71) Applicants: Northvolt AB, Stockholm (SE); Northvolt Revolt AB, Stockholm (SE)

(72) Inventors: Mahmood ALEMRAJABI, Solna (SE); Ragnar SJÖDAHL, Stockholm (SE); Emma NEHRENHEIM, Västerås (SE); Robert JENSEN, Västerås (SE)

(21) Appl. No.: 18/262,993

(22) PCT Filed: Feb. 7, 2022
(86) PCT No.: PCT/EP2022/052900

§ 371 Date: Jul. 26, 2023

(30) Foreign Application Priority Data
Feb. 8, 2021 (EP) 21155839.0

(51) Int. Cl. C22B 3/12; C22B 3/44

(52) U.S. Cl. CPC C22B 3/12; C22B 3/44

(57) ABSTRACT

The present invention relates to a process for producing a cathode active material precursor having a desired active material target ratio for use in a lithium-ion secondary cell or in the production of a lithium-ion secondary cell.

### TECHNICAL FIELD

The present invention relates to a process for producing a cathode active material precursor having a desired active material target ratio for use in a lithium-ion secondary cell.

### BACKGROUND

Rechargeable or secondary batteries find widespread use as electrical power supplies and energy storage systems. In particular in the transportation sector, to achieve the goal of the Intergovernmental Panel on Climate Change (IPCC) to limit global warming to 1.5° C., electric vehicles (EVs) powered by renewable energy have been tapped as the primary means to achieve decarbonization. As a result of the push from policymakers and global awareness, the number of electric vehicles worldwide will significantly increase in the next years and, as a consequence thereof, the number of batteries will also significantly rise. Rechargeable batteries can be based on various technologies, for example the nickel-cadmium (NiCd) or the nickel metal hydride (NiMH) technology. In the transportation sector, lithium-ion secondary batteries (LIBs) have become the most popular power source. In LIBs, lithium composite oxides including metals nickel, cobalt and/or manganese (so-called “NCM metals”) are typically used as cathode materials.

Economical and environmentally friendly production of batteries will become important factors for the development of better and cheaper rechargeable batteries and for meeting the IPCC goal. Recent approaches aim to directly integrate the preparation of battery precursor materials such as NiₓMn_{y}Co_{z}(OH)₂ in the recycling process of batteries (i.e., the recovering of active metals Ni, Co and Mn from spent batteries). Currently, recycling approaches can be divided into three main types: pyrometallurgical, hydrometallurgical and direct recycling. Pyrometallurgy uses elevated temperatures above 1000° C. to recover valuable metals in spent batteries, which makes this approach complicated from the viewpoint of vertical integration of recycling and battery manufacturing, and thus the whole process becomes uneconomical. Direct recycling recovers varied materials by physical processes, but this process has low flexibility and industrial potential. Hydrometallurgy employs multi-step treatments and chemical process to recover the valuable metals, including acid-base leaching of a feedstock including primarily black mass and alternatively mixed hydroxide precipitate (MHP) or mixed sulfide precipitate (MSP) to get the valuable metals like Ni, Co and Mn dissolved. Hydrometallurgy is the most cost efficient and effective method for vertical integration of recycling and battery manufacturing. However, current integration approaches using hydrometallurgy are based on the fact that the metals of interest such as Ni, Co and Mn are first transformed into a sulfate salt and then are converted into a sulfate solution. This requires extensive wastewater and effluent treatment and makes the process more complicated, which negatively effects both environmental and economic sustainability of the whole battery production process.

Considering the forecasted increasing number of batteries in the next years, in particular in the transportation sector, it is highly desirable to develop a simplified, cost-effective and resource-saving production process for cathode active material precursors that can be used for battery production processes, and in particular for LIBs.

### SUMMARY

In view of the above-outline requirements, an object of the present invention is to provide a process for producing a cathode active material precursor having a desired active material target ratio suitable for being used in a lithium-ion secondary cell or battery, or its production, which process is simple, cost-saving and resource-saving, and thus allows economical and environmentally friendly production of lithium-ion secondary batteries.

One or more of these objects may be solved by a process according to the independent claim 1. The independent claims and the dependent claims can be combined in any technologically suitable and sensible way, providing further embodiments of the invention.

Specifically, disclosed herein is a process for producing a cathode active material precursor having a desired active material target ratio for use in a lithium-ion secondary cell, the process comprising the steps:
a) providing a leachate comprising one or more active materials selected from Ni, Co and Mn;
b) identifying ionic impurities comprised in the leachate, and determining the concentration of each ionic impurity and of each active material in the leachate;
c) adjusting the concentration of the one or more active materials in the leachate based on a total concentration of ions in the leachate; and
d) raising the pH of the leachate to a level causing coprecipitation of the one or more active materials at a ratio corresponding to the desired active material target ratio for the precursor and causing coprecipitation of a minimum amount of ionic impurities, to obtain the precursor having the desired active material target ratio.

The present inventors have surprisingly found that the process disclosed herein, which can integrate battery precursor synthesis in the recycling of batteries, advantageously allows for reducing consumption of chemicals, water consumption, energy consumption and production of chemical by-products in the preparation of cathode active material precursors, and additionally allows for simplifying the production plant and effluent treatment. Thus, the process disclosed herein advantageously allows for cost-saving and resource-saving production of a cathode active material precursor for use in a lithium-ion secondary cell, and thus economical and environmentally friendly production of lithium-ion secondary batteries is ensured.

### BRIEF DESCRIPTION OF THE DRAWINGS

Different aspects are now described with reference to the accompanying drawings. Apparently, the accompanying drawings in the following description show merely some embodiments of this application, and a person of ordinary skill in the art may still derive other drawings from these accompanying drawings without creative efforts.

FIG. 1 is a schematic flowchart illustrating a state of the art process that integrates battery recycling with cathode active material precursor preparation. In step (A), a NMC feedstock such as black mass is leached under acidic reductive environment to get the active materials (Ni, Co and Mn) dissolved. In the next step (B), a number of operations including solvent extraction, precipitation and ionic exchange are employed to remove impurities, mainly F, P, Cu, Fe, Al and Zn. The leach solution containing mainly Ni, Co, Mn and Li are then passed by an NMC recovery unit (C), where NMC is recovered as sulfate salt using H₂SO₄. After NMC recovery, the mother liquor containing mainly Li and Na is fed to lithium recovery circuit (D), where LiOH and Na₂SO₄ is recovered using crystallization evaporation techniques. The NMC sulfate recovered in the recycling process is dissolved in deionized water (E). Thereafter, the concentration is adjusted in step (F) by addition of concentrated solutions of Ni, Co and Mn sulfate, in order to meet the correct ratio desired for the precursor material, before in step (G) the cathode active material precursor is coprecipitated in the form of NiₓCo_{y}Mn_{z}(OH)₂ particles by increasing the pH using NaOH solution. The precursor material obtained can then be further process and subjected to cathode active material synthesis.

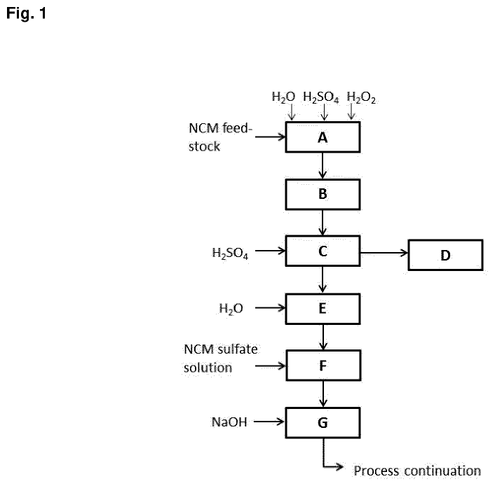

FIG. 2 is a schematic flowchart illustrating a process for cathode active material precursor preparation that integrates battery recycling according to an embodiment of the present disclosure. In step (N), a NMC feedstock such as black mass is leached under acidic reductive environment to get the active materials (Ni, Co and Mn) dissolved. In the next step (O), a number of operations including solvent extraction, precipitation and ionic exchange are employed to remove impurities, mainly Cu, Fe, Al and Zn. The leach solution containing Ni, Co, Mn, Li, Na and minor impurities, mainly Mg, Al and Ca, is fed to the concentration adjustment (P), where NMC sulfate solutions are added and the concentration is adjusted based on the total concentration of ions including impurities and NCM metals in the leachate. After this step, the leach solution is fed to the precursor precipitation unit (Q), where by increasing the pH using NaOH or LiOH solution the cathode active material precursor is coprecipitated in the form of NiₓCo_{y}Mn_{z}(OH)₂ particles. The precursor material obtained can then be further processed and subjected to cathode active material synthesis. After this step, the remaining Ni, Co and Mn left in the solution is precipitated in step (R) by further increasing the pH using NaOH and/or LiOH and recycled back to leach step (N) or concentration adjustment step (P). After NMC recovery, the mother liquor containing Li and Na is fed to lithium recovery circuit (S), where LiOH and Na₂SO₄ are recovered using crystallization evaporation techniques.

FIGS. 3a to 3f are SEM photographs of the precursor material prepared in Example 1 (FIGS. 3a to 3c) and a comparative precursor material (FIGS. 3d to 3f).

### DETAILED DESCRIPTION

The technical solutions of the embodiments of this application will be described in more detail below with reference to the accompanying drawings. It is obvious that the embodiments to be described are a part rather than all of the embodiments of this application. The features of various embodiments can be combined to form further exemplary aspects of the present disclosure that may not be explicitly described or illustrated. All other embodiments obtained by persons of ordinary skill in the art based on the embodiments of the present invention without making creative efforts shall fall within the protection scope of the present invention. Further it is to be understood that the words and terms employed herein are used for describing specific embodiments only, and is not intended to be limiting, since the scope of the present invention is defined by the appended claims and equivalents thereof.

Battery cells, or simply “cells”, in general comprise an anode, cathode, separator and electrolyte. The electrolyte acts as a conductor allowing ions to move between the positive electrode (cathode) and the negative electrode (anode) and in the reverse, in an oxidation and reduction reaction respectively. In lithium-ion secondary batteries (LIBs), lithium ions move from the anode to the cathode during discharge. As used herein, the term “battery” is intended to include a battery cell or cell, a battery module, which typically contains a plurality of battery cells, and a battery pack, which typically contain a plurality of battery modules.

Within the framework of this application, the terms “cathode materials” or “cathode active materials”, which terms are used interchangeably herein, describe the materials that constitute the cathode in a battery. In LIBs, lithium transition metal composite oxides including active metals nickel (Ni), cobalt (Co) and/or manganese (Mn) (so-called “NCM metals”) as the primary active component of the cathode are typically used as cathode materials. Common examples of cathode materials are lithium cobalt oxide (LiCoO₂), lithium nickel oxide (LiNiO₂), lithium manganese oxide (LiMn₂O₄), lithium nickel cobalt oxide (LiNiₓCo₁₋ₓO₂ (0≤x≤1)) as well as lithium nickel cobalt manganese (NCM) oxide (LiNi_{1-x-y}CoₓMn_{y}O₂ (0≤x≤0.5, 1≤y≤1.5)). Further, within the framework of this application, the terms “active materials” and “active metals” are used interchangeably to describe the transition metals that constitute the primary active component of the cathode material. In LIBs, the cathode material contains one or more selected from NMC metals Ni, Mn and Co as the active materials at a desired target ratio/target composition, wherein the molar ratio Li:active material(s) is typically near 1.

Further, within the framework of this application the indication that chemical elements (e.g. metals) are contained in a leachate or in any other solution, in a composite oxide that constitutes the cathode material, or the like, is understood to mean that these elements are contained therein in their respective ionic form (i.e., metals as cations, non-metals as anions).

In one aspect, a process is provided for producing a cathode material precursor having a desired active material target ratio for use in a lithium-ion secondary cell, wherein the process comprises the steps:
a) providing a leachate comprising one or more active materials selected from Ni, Co and Mn;
b) identifying ionic impurities comprised in the leachate, and determining the concentration of each ionic impurity and of each active material in the leachate;
c) adjusting the concentration of the one or more active materials in the leachate based on a total concentration of ions in the leachate; and
d) raising the pH of the leachate to a level that causes coprecipitation of the one or more active materials at a ratio corresponding to the desired active material target ratio for the precursor, and that causes coprecipitation of a minimum amount of ionic impurities, to obtain the precursor having the desired active material target ratio.

### Leachate Providing Step a)

For providing the leachate or leach solution, which terms are used interchangeably herein, a feedstock including one or more active metals selected from Ni, Co and Mn is leached, for example using an acid or base, or an acidic or basic solution, in particular aqueous solution, as a leach agent to thereby dissolve the active metals in their ionic forms (i.e., Ni²⁺, Co²⁺, Mn²⁺) in the leach solution. It is to be understood that such acid or alkaline leaching may also results in dissolution of certain amounts of other elements commonly contained in the feedstock depending on its source, such as lithium (Li), phosphorus (P), fluorine (F), manganese (Mg), sodium (Na), calcium (Ca) and/or silicon (Si), but also copper (Cu), iron (Fe), aluminum (Al) and/or zinc (Zn), without being limited thereto. These elements other than active metals Ni, Co and Mn, which consequently are also dissolved in the leach solution, are referred to herein as “ionic impurities”.

The feedstock can be obtained from different sources, and is preferably a feedstock that originates from crushed battery material, the so-called “black mass”, in particular material of crushed lithium ion batteries, or is a feedstock of raw materials or recycled materials such as mixed hydroxide precipitate (MHP) and mixed sulfide precipitate (MSP), or any combination thereof. Therefore, in a preferred embodiment of the process, the leachate is provided from one or more of a crushed battery material (i.e., black mass), in particular crushed lithium ion battery material, a raw materials feedstock and a recycled materials feedstock.

Crushing batteries to obtain a crushed battery material is typically a process step in the recycling of waste/spent batteries to recover desirable and valuable battery materials, in particular cathode active materials. Recycling of batteries usually starts by sorting waste batteries according to their chemical composition, and then crushing or shredding the waste batteries. A battery comprises various materials, including plastics and metals that make up the battery housing, the cathode and anode materials, and an electrolyte. After crushing, a series of filtering and sieving steps are typically performed to separate off plastic and metal shreds and to obtain a refined crushed battery material called “black mass”, which mainly contains cathode and anode materials. The composition of black mass typically varies, as the sorting of the batteries is difficult or neglected. Examples of different compositions of black mass (BM) obtained from LIBs and rich in either nickel, NCM or cobalt is given in Table 1 below.

TABLE 1
Composition of black mass (BM)

| | Al | Ni | Co | Mn | Li | Fe | Cu | C/Graphite |
|---|---|---|---|---|---|---|---|---|
| Nickel rich BM (wt. %) | 3 | 21.13 | 2.67 | 2.47 | 3.71 | 0.90 | 3.89 | 35-45 |
| NCM rich BM (wt. %) | 3 | 9.61 | 9.4 | 9.12 | 3.95 | 0.12 | 4.25 | 35-45 |
| Cobalt rich BM (wt. %) | 3 | 0.10 | 26.41 | 0.10 | 3.70 | 0.90 | 3.89 | 35-45 |

As used herein, the term “black mass” thus describes the crushed or shredded cathode and anode materials of batteries after the removal of plastic and solid metal parts.

The leaching of the black mass or feedstock for providing the leachate may be performed by various different methods known to the skilled person, such as acid leaching, alkaline leaching or acid roasting, without being limited thereto, but acid leaching using an acid or acid solution, in particular aqueous solution, as the solvent/leach agent is preferred.

In one embodiment of the present disclosure, to provide the leachate in the step a) leaching is performed in the presence of a reducing agent. According to one embodiment, which is especially suitable for leaching black mass, acid leaching is preferably performed at atmospheric pressure using sulfuric acid (H₂SO₄), preferably at a concentration in the range of 2-5 M (molar), as the leach agent and hydrogen peroxide (H₂O₂) as a reducing agent.

According to this embodiment, the leachate typically has a pH below 1.5, for example below 1, and preferably below 0.7, for example about pH 0.5.

According to another embodiment of the process, which is especially suitable for leaching mixed metal sulfide precipitate (MSP), high pressure oxidative leaching is performed.

During the leaching, the metallic elements contained in the feedstock including NCM metals Ni, Co and Mn are transferred to the leach solution, thereby providing a leachate comprising one or more active materials selected from Ni, Co and Mn. It primarily depends on the composition of the black mass or feedstock used which of active materials Ni, Co, and Mn the leachate finally contains, and their respective amounts or concentrations in the leachate depend on the composition of the black mass or the feedstock used and the conditions applied during leaching.

The leaching residue, which mainly consists of graphite, plastic pieces and undissolved metals, may be filtered for example through a hydraulic filter press, and may be washed with water to remove adsorbed and/or encapsulated mother liquor.

According to a further preferred embodiment, the leachate comprises two or more active materials selected from Ni, Co and Mn. According to a more preferred embodiment, the leachate comprises active materials Ni, Co and Mn.

### Impurity Identifying Step b)

As indicated above, other metals and/or elements besides the NCM metals may be contained in the black mass or the feedstock used for leaching, which mainly originate from the cathode and anode materials that make up the black mass. These unwanted other metals and/or elements may also be transferred to the leach solution during the leaching, and consequently may be contained in the leachate as ionic impurities, in particular lithium (Li), phosphorus (P), fluorine (F), manganese (Mg), sodium (Na), calcium (Ca) and/or silicon (Si), but also copper (Cu), iron (Fe), aluminum (Al) and/or zinc (Zn), without being limited thereto.

The solubility of an ionic compound (salt) in a solvent (i.e., the solubility product), which is a function of the pH of the solution, in general is affected by the presence and concentration of other ionic compounds. Therefore, in a further process step, all the ionic impurities comprised in the leachate are identified, and for each ionic impurity identified, its concentration in the leachate is determined. In addition, the concentration of each active metal Ni, Cu and/or Mn contained in the leachate is determined. By this, a total concentration of ions in the leachate can be calculated.

By knowing the total concentration of ions including ionic impurities and active metals in the leach solution, the solubility of each active metal Ni, Cu and/or Mn contained in the leach solution (i.e., the solubility product) at a certain pH of the leach solution can be calculated.

For identifying the ionic impurities and determining the concentration of each ionic impurity and of each active metal Ni, Cu and/or Mn comprised in the leachate any chemical analysis method known to the skilled person can be employed, for example Inductively Coupled Plasma-Optical Emission Spectrometry (ICP-OES) or Atomic absorption spectroscopy (AAS) may be used preferably, without being limited thereto.

Typically, the leachate obtained from black mass comprises one or more of Li, P, F, Mg, Na, Ca, and Si as ionic impurities. Additionally, one or more of Cu, Fe, Al and Zn may be comprised in the leachate as further ionic impurities.

According to a preferred embodiment, the leachate obtained in step a) comprises at least Li as ionic impurity. According to a further preferred embodiment, the leachate in step a) is obtained from leaching black mass of crushed lithium ion batteries and comprises at least Li as ionic impurity.

In a further preferred embodiment, the leachate obtained in step a) is substantially free of Cu, Fe, Al and Zn, which means that the leachate contains substantially no Cu, Fe, Al and Zn, or only small amounts of Cu, Fe, Al and/or Zn, preferably less than 10 ppm, more preferably less than 5 ppm of Cu and/or Fe and/or Al and/or Zn. In the alternative, the leachate may comprise one or more of Cu, Fe, Al and Zn as further ionic impurities.

In case one or more of Cu, Fe, Al and Zn are identified to be comprised in the leachate obtained in step a) as further ionic impurities, a step of removing Cu, Fe, Al and/or Zn from the leachate may be performed, preferably before a step of adjusting the concentration that will be described below is performed.

Therefore, according to another preferred embodiment, the process further comprises a step of removing Cu, Fe, Al and Zn from the leachate, preferably before the step c) of adjusting the concentration. Al and Fe are preferably removed from the leachate using precipitation, preferably by increasing the pH of the leachate to 3-5 using a base including, but not limited to, NaOH, KOH, LiOH, H₃PO₄, MgCO₃, Na₂CO₃ or Ni, Co and Mn hydroxide (NCM hydroxide). Cu can be removed before or subsequent to the removal of Fe and Al, and is preferably removed from the leachate through solvent extraction, for example by using LIX® diluted in kerosene as the solvent extractant, or through precipitation.

In embodiments wherein the removal of Cu is carried out before the removal of Fe and Al, the pH of the leachate is first increased to 1-1.4 by addition of a base, preferably one or more of the bases mentioned above in connection with the removal of Al and Fe, and more preferably NCM hydroxide, to remove Cu from the leachate preferably through solvent extraction using, for example, LIX® diluted in kerosene, and then the pH of the leachate is further increased to 3-5 in one or more precipitation stages, preferably by addition of NCM hydroxide, to precipitate Al, Fe, remaining Cu and Zn. NCM hydroxide is preferably used to increase the pH of the leachate in order to avoid introduction of further ionic impurities into the leachate.

The precipitates at the one or more precipitation stage may be removed by filtration using, for example, a filter press. After precipitation, traces of remaining Fe, Al, Zn and Cu may be removed from the leachate by ion exchange using an ion exchange unit or bed.

According to this embodiment, the leach solution after removal of Cu, Fe, Al and/or Zn has a pH of about 4 to 5.

This process step results in an effective removal of Cu, Fe, Al and Zn, while minimizing unwanted removal of the valuable active metals Ni, Co and Mn. At the same time, this process step results in the production of a leach solution which is substantially free of Cu, Fe, Al and Zn, preferably containing less than 10 ppm, more preferably less than 5 ppm of Cu and/or Fe and/or Al and/or Zn. After such impurity removal, the leach solution mainly contains active metals Ni, Co and/or Mn, and highly soluble impurities such as Li and/or Na, and/or in minor amounts Mg and Ca. It is to be understood that in embodiments of the process of the present disclosure which include a step of removing of Cu, Fe, Al and/or Zn from the leachate before the concentration adjusting step c), the concentration of each of Cu, Fe, Al and Zn in the leachate before their removal does not amount to the total concentration of ions in the leachate.

### Concentration Adjusting Step c)

Next, in the process of the present disclosure for each of the one or more active materials selected from Ni, Co and Mn in the leachate, which is substantially free of Cu, Fe, Al and Zn, the concentration is adjusted based on the total concentration of ions including ionic impurities and active metals in the leachate, preferably by addition of respective Ni, Co and Mn raw materials.

This means that the concentration of Ni, Co and/or Mn in the leachate is adjusted to be “above” (i.e., at a higher concentration than) the desired target ratio of the active material(s) for the precursor, preferably by adding excess amounts of the respective Ni, Co and/or Mn raw materials, however the decision which concentration of Ni, Co and/or Mn is set in the leachate/which excess amounts of the respective Ni, Co and Mn raw materials are added to the leachate depends on the concentration of the ionic impurities and the initial concentration of Ni, Co and/or Mn in the leachate, and thus from the solubility of Ni, Co and/or Mn in the leachate (and of course from the desired composition of the precursor material).

When taking into account the total concentration of ions in the leachate, the solubility of each active metal Ni, Co and/or Mn (i.e., its solubility product) in the leachate at a certain pH of the leachate can be calculated, which allows adjusting the concentration of each active metal such that precipitation of the precursor at the desired target ratio of active materials can be ensured, despite the presence of one or more ionic impurities.

According to a preferred embodiment of the process, the concentration adjustment of the one or more active materials in the leachate to the desired level is conducted by addition of a salt or salt solution of the respective one or more active materials as the raw material. As used herein, the term “salt” is to be understood to include hydroxides. For example, sulfates, nitrates, carbonates, acetates, hydroxides or chlorides of Ni, Co and/or Mn may be used as salts, and preferably are directly added to the leachate in amounts appropriate to adjust the concentration to the desired level, or respective salt solutions may be prepared first, which are then added to the leachate such that the concentration of Ni, Co and/or Mn is adjusted to the desired level. The kind of salt can be chosen independently for each of the active materials, but preferably the same kind of salt is used for each active material, for example nickel sulfate, copper sulfate and manganese sulfate, as appropriate.

More preferably, the concentration of the one or more active materials in the leachate is adjusted by addition of sulfates or hydroxides, or sulfate or hydroxide solutions, of the respective one or more active materials.

In addition, the concentration adjustment may further comprise addition of one or more of additives, such as NH₃, Al₂O₃ and MgSO₄, which may act as chelating agents.

In processes for producing a cathode material precursor according to current integration approaches, before the concentration of the NCM metals in the leachate is adjusted, and after impurity removal to lower the content of impurities such as F, P, Cu, Fe, Al and Zn in the leachate, the NMC metals contained in the leachate are first recovered as NCM sulfate salts, and are then converted into a NCM sulfate solution by dissolving the NCM sulfate salts in water. Thereafter, the concentration of each of Ni, Co and/or Mn in the leachate is adjusted by addition of concentrated solutions of nickel, cobalt and/or manganese sulfate to meet the correct desired target ratio of the active material(s) for the precursor.

Having a NCM sulfate salt as an “intermediate product” not only increases the total water balance and consumption of chemicals, which makes wastewater and effluent treatment more complicated, but also the impurity removal on the recycling process would be complicated as some of the impurities such as Al, Mg and Li need to be removed down to ppm level, thereby increasing the process complexity and the overall operating cost.

Contrary to prior art processes, according to the process of the present disclosure no such step of recovering the active materials contained in the leachate is performed before the concentration adjustment of the one or more active materials in the leachate. By this, water consumption and the consumption of chemicals are reduced, wastewater and effluent treatment get less complicated and the process is simplified.

### Coprecipitation Step d)

After the concentration of each active material Ni, Co and/or Mn contained in the leachate is adjusted to the desired level based on the total concentration of ions in the leachate (i.e., to be “above” the desired target ratio of the active material(s) for the precursor, as described above), the pH of the leachate is raised to a level causing coprecipitation of the one or more active materials at a ratio corresponding to the desired active material target ratio for the precursor, and at the same time causing coprecipitation of only a minimum amount of ionic impurities still contained in the leachate, such as Li, P, F, Mg, Na, Ca and Si. This means, the pH of the leachate is raised until the desired amount of Ni, Co and/or Mn is (co-)precipitated for forming the precursor with the desired active material target ratio. As the concentration of the active materials Ni, Co and/or Mn has been properly adjusted considering the total concentration of ions in the leachate, precipitation of the one or more active materials at a ratio corresponding to the desired active material target ratio for the precursor is ensured at a relatively low pH, which is below the pH at which the ionic impurities substantially start to precipitate.

Contrary to processes for producing a cathode material precursor according to current integration approaches, wherein an intermediate NCM salt is produced and impurity removal is complicated, such additional steps are not required in the process of the present disclosure, as the concentration adjustment effects that Ni, Co and/or Mn coprecipitate in the ratio desired for the precursor at relatively low pH, leaving behind in the leachate unprecipitated Ni, Co and/or Mn together with ionic impurities.

Accordingly, as the process of the present disclosure allows synthesis of the precursor material at relatively higher concentration of impurities, the impurity removal circuit during battery recycling is simplified and therefore the whole process is simplified, thereby making the integration of battery recycling and precursor manufacturing cost effective.

Preferably, the pH of the leachate is raised to a level in the range of 8 to 10, more preferably 8 to 9, to cause coprecipitation of the one or more NCM metals in the desired target ratio for the precursor and to avoid co-precipitation of the impurities in the leachate with the precursor.

The pH of the leachate is preferably raised to the desired level to cause co-precipitation by addition of sodium hydroxide (NaOH), lithium hydroxide (LiOH), potassium hydroxide (KOH) or ammonium hydroxide (NH₄OH), or any combination thereof, to the leachate.

By the process of the present disclosure, a cathode material precursor is obtained by coprecipitating the one or more active materials selected from Ni, Co and Mn as a combined hydroxide having a molar ratio of the active materials as desired. The precursor can subsequently be subjected to a cathode active material production process. The leachate remaining after coprecipitation (i.e., the mother liquor) can be subjected to subsequent recovery treatments as will be described below.

In a preferred embodiment of the process, the leachate comprises two or more active materials selected from Ni, Co and Mn, and more preferably Ni, Co and Mn as active materials, each at the respective desired concentration level, and the cathode material precursor is obtained in step d) by raising the pH of the leachate by addition of sodium hydroxide to a range of 8 to 10 for precipitating cathode material precursor as a hydroxide.

The cathode active material precursor obtained by the process of the present disclosure is preferably in the form Ni(OH)₂, Mn(OH)₂, Co(OH)₂, NiₓCo_{y}(OH)₂, NiₓMn_{z}(OH)₂, Co_{y}Mn_{z}(OH)₂ or NiₓCo_{y}Mn_{z}(OH)₂, without being limited thereto, where x, y, and z are defined corresponding to the desired active material target ratio. More preferably, the precursor is in the form NiₓCo_{y}Mn_{z}(OH)₂, meaning that the leachate comprises Ni, Co and Mn as the active materials. For example, if the precursor produced corresponds to NiₓMn_{y}Co_{z}(OH)₂, the desired active material target ratio Ni:Co:Mn may be, for example, 0.8:0.1:0.1, 0.83:0.085:0.085, 0.85:0.075:0.075 or 0.90:0.05:0.05.

The coprecipitated cathode material precursor may be separated from the leachate by any method known to the skilled person, but filtration is preferred. The separated cathode material precursor may subsequently be washed with water to remove residual leach solution (i.e., mother liquor). Therefore, according to a further preferred embodiment the process further comprises a filtration step, to separate the precipitated cathode material precursor from the leach solution, and an optional subsequent washing step to remove residual leach solution, preferably with water.

As mentioned above, a certain amount of the NCM metals in the leachate may not coprecipitate in step d), but remains in the mother liquor after the cathode material precursor is obtained. In order to save resources and to enhance sustainability, at least a part of this remaining amount of NCM metals may be recycled, and may for example be recycled back to a leachate providing step (i.e., corresponding to leachate providing step a)) or to a concentration adjustment step for adjusting the concentration of active materials (corresponding to concentration adjustment step c)).

Therefore, in a further embodiment, the process according to the present invention further comprises recycling of at least a part of a remaining amount of the one or more active materials selected from Ni, Co and Mn that is remaining in the leachate after coprecipitation in step d), preferably by recycling back to a leachate providing step or to a concentration adjustment step.

Preferably, the recycling of at least a part of the remaining amount of the one or more active materials selected from Ni, Co and Mn includes raising the pH of the mother liquor, preferably by addition of NaOH, LiOH or KOH, more preferably NaOH, to a level that causes precipitation of at least a part of the one or more active materials as hydroxides.

Further preferably, at least 50%, at least 60%, at least 70, at least 80%, at least 90% or substantially 100% of the one or more active materials selected from Mi, Co and Mn remaining in the mother liquor after coprecipitation step d) are precipitated as hydroxides and recycled.

As mentioned above, according to a preferred embodiment, the leachate obtained in step a) comprises at least lithium as ionic impurity, in particular when the leachate in step a) is obtained from leaching black mass of crushed lithium ion batteries.

According to a further preferred embodiment, which presumes that the leachate obtained in step a) comprises lithium, the process comprises, alternatively or in addition to recycling of the remaining amounts of NCM metals, recovering of lithium from the leach solution (i.e. mother liquor) after coprecipitating the cathode material precursor.

The lithium may be recovered from the leach solution for example by first precipitating the lithium as lithium carbonate (Li₂CO₃) using sodium carbonate (Na₂CO₃) or potassium carbonate (K₂CO₃), and then conversion into LiOH by reacting Li₂CO₃ with KOH or NaOH.

Sodium sulfate (Na₂SO₄) and/or potassium sulfate (K₂SO₄) may be generated as a by-product of the process of the present disclosure, mainly resulting from the addition of NaOH or Na₂CO₃ and/or KOH or K₂CO₃ to the leach solution during the process. According to a further preferred embodiment, the solution containing Na₂SO₄ and/or K₂SO₄ is sent to a crystallization unit, optionally after precipitation of lithium, where Na₂SO₄ and/or K₂SO₄ crystals are produced by means of evaporation crystallization and separated.

The process disclosed herein advantageously allows for reducing consumption of chemicals, water consumption, energy consumption and production of chemical by-products in the preparation of cathode active material precursors, Furthermore, the production plant and effluent treatment is simplified. Thus, the process disclosed herein advantageously allows for cost-saving and resource-saving production of a cathode active material precursor for use in a lithium-ion secondary cell, and therefore economical and environmentally friendly production of lithium-ion secondary batteries is ensured.

Without further elaboration, it is believed that a person skilled in the art can, using the present description including the accompanying drawings, utilize the present invention to its fullest extent. Although the invention has been described herein with regard to its preferred embodiments, which represent the best mode for carrying out the invention, it is understood that various changes as would be obvious to one of ordinary skill in this art can be made without departing from the spirit and scope of the disclosure, which is set forth in the appended claims.

In the following, the present disclosure will be explained using examples, but the present disclosure is not limited to these examples.

### EXAMPLE 1: PREPARATION OF CATHODE MATERIAL PRECURSOR Ni_{0.83}Mn_{0.05}Co_{0.12}(OH)₂

The metals (active metals and impurities) and their concentrations in the leach solution are determined by ICP-OES (Inductively Coupled Plasma-Optical Emission Spectrometry) using an ICP emission spectrophotometer (iCAP PRO XP Duo from Thermofisher scientific).

### Example 1a): Leaching

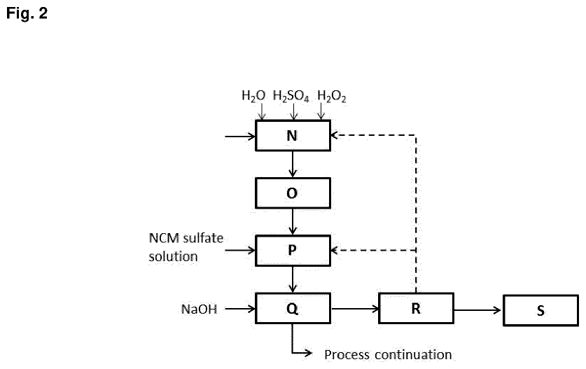

As schematically shown in FIG. 2, step N, an aqueous solution of 3.2 mole sulfuric acid and 5 vol.-% hydrogen peroxide prepared by mixing 125 g sulfuric acid (96%), 390 g deionized water and 27 g hydrogen peroxide (49%) is mixed with 100 g black mass obtained from crushed lithium ion batteries and having the following composition in weight percent presented in Table 1: (the rest of the mass is mainly graphite, oxygen, organic matters and Fluoride.)

TABLE 1

Nickel (Ni): 25.15%
Cobalt (Co): 3.77%
Manganese (Mn): 1.8%
Lithium (Li): 3.6%
Sodium (Na): 0.02%
Magnesium (Mg): 0.01%
Aluminum (Al): 0.52%
Copper (Cu): 2.01%
Zinc (Zn): 0.08%
Iron (Fe): 0%
Calcium (Ca): 0.03%
Silica (Si): 0.06%

Undissolved solids, mainly graphite, are separated by filtration using a filter press. The pH of this filtrate/leach solution is 0.5.

The concentrations of the metals (active metals and impurities) contained in this filtrate/leach solution are shown in Table 2

TABLE 2

Nickel (Ni): 48000 ppm
Cobalt (Co): 6900 ppm
Manganese (Mn): 2750 ppm
Lithium (Li) 7300 ppm
Sodium (Na): 160 ppm
Magnesium (Mg): 2 ppm
Aluminum (Al): 1100 ppm
Copper (Cu): 3000 ppm
Zinc (Zn): 20 ppm
Iron (Fe): 30 ppm
Calcium (Ca): 25 ppm
Silica (Si): 50 ppm

### Example 1b): Impurity Removal

With reference to step O in FIG. 2, the pH of the leach solution obtained from leaching in Example 1a) is increased to 1-1.4 by adding 110 g nickel-, cobalt- and manganese hydroxide (NMC—OH) slurry with 25 wt % mass of dry NMC—OH. Copper is then removed from the leach solution through solvent extraction using a mixture of LIX® and Kerosene as an organic phase. After removal of copper, the pH of the leach solution is further increased by addition of 76 g NMC—OH slurry to precipitate Al, Fe, remaining Cu and Zn as hydroxides at different precipitation stages. The precipitates at each stage of precipitation are removed using a filter press. The filtrate/leach solution obtained is then passed through an Ionic Exchange (IX) column using a cation-exchange resin (Puromet™ MTS9500 in Na⁺ form, produced by Purolite) to remove remaining traces of Al, Fe, Cu and Zn from the leach solution. The pH of the leach solution after this impurity removal is 4.

The concentrations of the metals (active metals and impurities) in the leach solution after impurity removal are shown in Table 3.

TABLE 3

Nickel (Ni): 52000 ppm
Cobalt (Co): 12000 ppm
Manganese (Mn): 18000 ppm
Lithium (Li) 5000 ppm
Sodium (Na): 1400 ppm
Magnesium (Mg): 2 ppm
Aluminum (Al): 0 ppm
Copper (Cu): 0 ppm
Zinc (Zn): 0 ppm
Iron (Fe): 0 ppm
Calcium (Ca): 15 ppm
Silica (Si): 20 ppm

### Example 1c): Concentration Adjustment

Considering the concentrations of the metals (active metals and impurities) in the leach solution after impurity removal given in Table 3, the total concentration of active metals and impurities is calculated to be equivalent of 1.41 mold of total Ni, Co and Mn, where the target NMC concentration before the co-precipitation process is 1.55 mold.

To achieve precipitation of the desired cathode material precursor Ni_{0.83}Mn_{0.05}Co0.12(OH)₂ having an active material target ratio Ni:Co:Mn of 0.83:0.05:0.12, the active material ratio of Ni:Co:Mn in the leach solution is adjusted by addition of respective amounts of NiSO₄, CoSO₄, MnSO₄ to the leach solution as schematically shown in FIG. 2, step P, to adjust a target Ni:Mn:Co ratio of 0.815:0.08:0.105 and a higher concentration equivalent of 1.59 mol/l.

The concentrations of the metals (active metals and impurities) in the leach solution after concentration adjustment are shown in Table 4.

TABLE 4

Nickel (Ni): 76060 ppm
Cobalt (Co): 9840 ppm
Manganese (Mn): 6990 ppm
Lithium (Li) 3500 ppm
Sodium (Na): 980 ppm
Magnesium (Mg): 1 ppm
Aluminum (Al): 0 ppm
Copper (Cu): 0 ppm
Zinc (Zn): 0 ppm
Iron (Fe): 0 ppm
Calcium (Ca): 12 ppm
Silica (Si): 14 ppm

### Example 1d): Co-Precipitation

With reference to FIG. 2, a continuous stirred-tank reactor (CSTR) is employed as the precipitation unit Q. The leach solution obtained after concentration adjustment in Example 1c) is fed to the CSTR. The co-precipitation is performed in a continuous process which uses addition of sodium hydroxide and ammonium hydroxide to increase the pH of the leach solution to 9 to precipitate the precursor material. The precipitated precursor material is separated from the filtrate/leach solution by filtration using a filter press, and washed with de-ionized water to remove residual filtrate/leach solution.

The precursor material thus obtained has the composition Ni_{0.83}Mn_{0.05}Co_{0.12}(OH)₂. The tap density of the prepared precursor material is 1.55 g/cm³ and the particle size distribution of D₅₀ is 5 μm as determined by laser diffraction (LD) employing a commercially available particle size analyzer (Manufacturer: Malvern Panalytical).

### EXAMPLE 2: COMPARISON OF PRECURSOR MATERIAL AND ELECTROCHEMICAL PERFORMANCE TESTING

The precursor material prepared in Example 1 is compared to a precursor material having the composition Ni_{0.83}Mn_{0.05}Co_{0.12}(OH)₂ and being prepared directly by co-precipitation from nickel, cobalt and manganese raw materials (i.e., the comparison material), and the electrochemical performance of samples of both materials is tested.

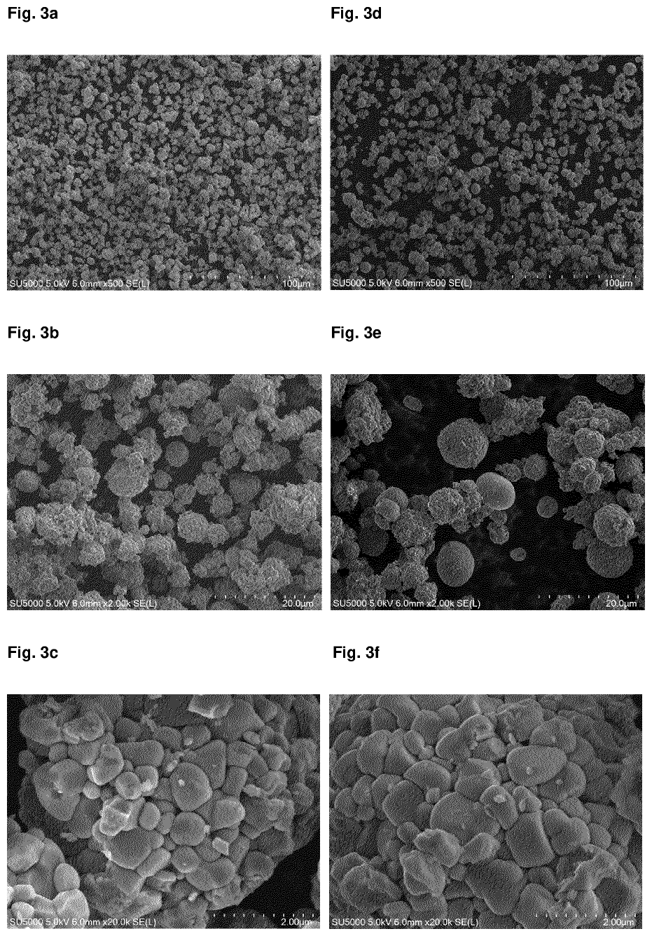

Crystallographic data of the precursor material prepared in Example 1 and the comparison material reveal similar XRD patterns for both materials. Further, SEM photographs of powders of the precursor material prepared in Example 1 (FIGS. 3a to 3c) and of the comparison material (FIGS. 3d to 3f) show microsized particles of spherical shape and confirm a similar structure of secondary particles for both materials.

Electrochemical performance of the precursor samples are measured using cycling test between 2.8 to 4.2 V with stress cycling using 1 c/rate, followed by capacity checks after every 100 cycle using crate 0.2. The results shows that after 1100 cycles 81% of the capacity retention of samples is observed for both, the precursor material prepared in Example 1 and the comparison material.

The above structural comparison and test results show that the quality and electrochemical performance of the material obtained by the process of the present disclosure is not affected or even deteriorated compared to a precursor material directly prepared from respective raw materials, and that the process of the present disclosure is excellently suited for producing a precursor for a cathode active material.

1. Process for producing a cathode material precursor having a desired active material target ratio for use in a lithium-ion secondary cell, the process comprising the steps:
a) providing a leachate comprising one or more active materials selected from Ni, Co and Mn;
b) identifying ionic impurities comprised in the leachate, and determining the concentration of each ionic impurity and of each active material in the leachate;
c) adjusting the concentration of the one or more active materials in the leachate based on a total concentration of ions in the leachate; and
d) raising the pH of the leachate to a level causing coprecipitation of the one or more active materials at a ratio corresponding to the desired active material target ratio for the precursor and causing coprecipitation of a minimum amount of ionic impurities, to obtain the cathode material precursor having the desired active material target ratio.

2. Process according to claim 1, wherein the leachate comprises as the ionic impurities one or more of Li, P, F, Mg, Na, Ca, and Si.

3. Process according to claim 1, wherein the concentration of the one or more active materials in the leachate is adjusted by addition of a salt or salt solution of the respective one or more active materials.

4. Process according to claim 1, wherein the concentration of the one or more active materials in the leachate is adjusted by addition of a sulfate or hydroxide salt, or a sulfate or hydroxide solution, of the respective one or more active materials.

5. Process according to claim 1, wherein the pH is raised to a level in the range of 8 to 10.

6. Process according to claim 1, wherein the pH of the leachate is raised by addition of NaOH, LiOH, KOH or ammonium hydroxide, or any combination thereof.

7. Process according to claim 1, wherein the cathode active material precursor obtained is in the form NiₓMn_{y}Co_{z}(OH)₂, NiₓCo_{z}(OH)₂, NiₓMn_{y}(OH)₂ or Mn_{y}Co_{z}(OH)₂, where x, y, and z are defined corresponding to the desired active material target ratio.

8. Process according to claim 1, wherein the leachate comprises two or more active materials selected from Ni, Co and Mn.

9. Process according to claim 1, wherein the leachate provided in step a) comprises one or more of Cu, Fe, Al and Zn as further ionic impurities, and the process comprises a step of removing the Cu, Fe, Al and Zn from the leachate.

10. Process according to claim 1, wherein the process further comprises recycling of at least a part of a remaining amount of the one or more active materials in the leachate after coprecipitation in step d).

11. Process according to claim 1, wherein the leachate comprises Li, and the process further comprises, after coprecipitation to obtain the precursor, recovering of Li from the leachate.

12. Process according to claim 1, wherein the pH is raised to a level in the range of 8 to 9.

13. Process according to claim 1, wherein the leachate comprises comprises Ni, Co and Mn.

14. Process according to claim 9, wherein the step of removing the Cu, Fe, Al and Zn from the leachate occurs before the step of adjusting the concentration.

15. Process according to claim 10, wherein the recycling of the at least a part of a remaining amount of the one or more active materials in the leachate comprises recycling back to a leachate-providing step or a concentration adjustment step.

16. Process according to claim 2, wherein the concentration of the one or more active materials in the leachate is adjusted by addition of a salt or salt solution of the respective one or more active materials.
